(19) United States
(12) Patent Application Publication
(10) Pub. No.: US 2006/0157666 A1
(43) Pub. Date: Jul. 20, 2006

(54) Cartridge base

(76) Inventor: Andreas Ginter, Schramberg-Heiligenbronn (DE)

Correspondence Address: DUANE MORRIS, LLP;IP DEPARTMENT, 30 SOUTH 17TH STREET, PHILADELPHIA, PA, 19103-4196, US

(21) Appl. No.: 11/321,430

(22) Filed: Dec. 29, 2005

(30) Foreign Application Priority Data
Jan. 4, 2005 (DE) 102005001309.0

(51) Int. Cl. F16K 27/00

(52) U.S. Cl. 251/366

(57) ABSTRACT

In order to make a cartridge usable for different sealing systems, a cartridge base is proposed into whose opening, which serves the passage of water into the valve system contained in the cartridge, a sleeve can be inserted. The sleeve juts beyond that end face of the cartridge base which faces the fitting housing, into the fitting housing. Between the radial outer side and a recess in the fitting housing, a seal can be placed. The cartridge base can also be used for those cases where a sealing system is already present in the fitting housing. In this case, the sleeve is simply removed.

The invention relates to a cartridge base for a valve cartridge.

In sanitary fittings, the use of cartridges for the actual valve mechanism has gained acceptance. Lines for the water making its way to the valve and the lines for the water leading to the outlet are present in the fitting housings. The cartridges are inserted into the fitting housing and, upon insertion, establish with the aid of their base, through matching openings, the connections with the lines of the fitting housings.

The cartridges, as they are inserted into the fitting housing, must be sealed against the latter. For this purpose, it is known to place the seal between the cartridge and the fitting into a groove in the cartridge base. In this case, that area in the fitting housing on which the cartridge rests with its seal must be of plane configuration.

There are also, however, fitting housing constructions in which special sealing systems are disposed in the fitting, for example hydraulically pretensioned sealing systems. In these cases, the cartridge must have a flat base complementary thereto.

As a result of these two different sealing systems, the advantage of the usability of cartridges for different fittings is actually negated.

The object of the invention is to provide a facility which allows a cartridge to be used also for these two different application systems.

In order to achieve this object, the invention proposes a cartridge base having the features stated in claim 1 and a cartridge having such a cartridge base. Refinements of the invention are the subject of subclaims.

With the aid of the sleeve which can be inserted into the cartridge base, a groove can virtually be simulated into which a seal can then be placed. In those cases in which the fitting housing contains a sealing system, the sleeve can be removed, with the result that the cartridge base is then flat, which is necessary for a seal present in the housing. With a single cartridge base, both the different sealing systems can thus be used, so that the versatility of use of cartridges is further reinforced.

The sleeve must remain fixed in the cartridge base only while the cartridge is installed into the fitting. For its fastening, it can be designed for securement by force closure, which can be realized by appropriate dimensioning of the inner circumference of the opening and the outer circumference of the sleeve.

It is equally possible, however, and lies within the framework of the invention, for the sleeve to be secured by form closure.

In order to ensure that the hydraulic characteristics of the valve system disposed in the cartridge housing are not altered, according to the invention the opening in the outer face of the cartridge base can be widened, so that, once the sleeve is inserted, no reduction in flow cross section or only a slight reduction in flow cross section occurs.

For example, the opening can have in its side walls an undercut for the engagement of latching elements of the sleeve. The sleeve can then be snaplocked in.

It is equally possible, however, for the opening to have in its side walls latching elements for engagement in undercuts in the outer side of the sleeve.

According to the invention, it can be envisioned in a refinement thereof that the outer face of the cartridge base outside the opening, or, in the case of a plurality of openings, outside these openings, is smooth-surfaced.

In a refinement of the invention, the outer face of that part of the sleeve which juts out of the cartridge base when the sleeve is mounted is preferably smooth. In a suitable arrangement, this face is borne against by the seals.

The invention likewise proposes a combination of a cartridge base as herein described and a fitting housing in which a water discharge opening in the fitting housing is surrounded by a widening which can then be used for the insertion of a seal.

Further features, details and preferences of the invention emerge from the claims and the abstract, both of whose wording is formulated by reference to the content of the description, the following description of a preferred embodiment of the invention and with reference to the drawing, in which:

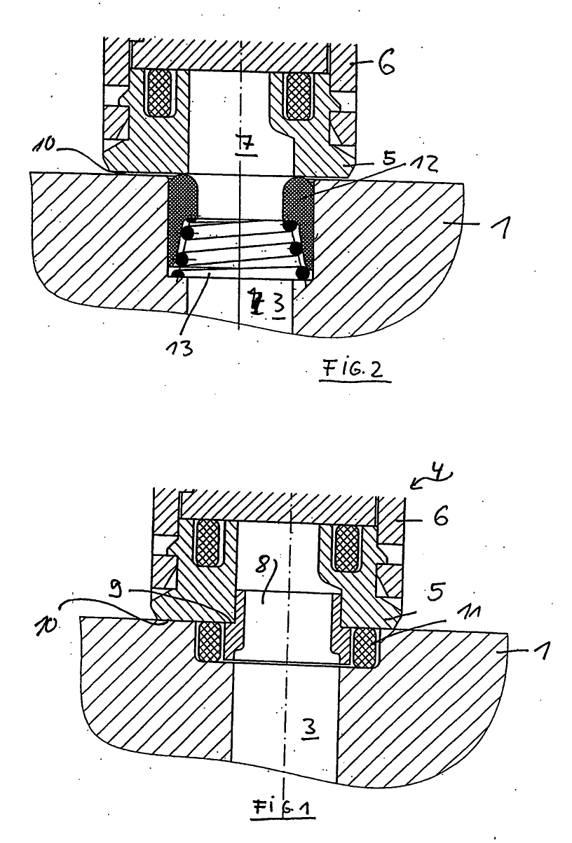

FIG. 1 shows a fragmented section through a cartridge base seated on a part of a fitting housing;

FIG. 2 shows a representation corresponding to FIG. 1 with respect to a different type of seal;

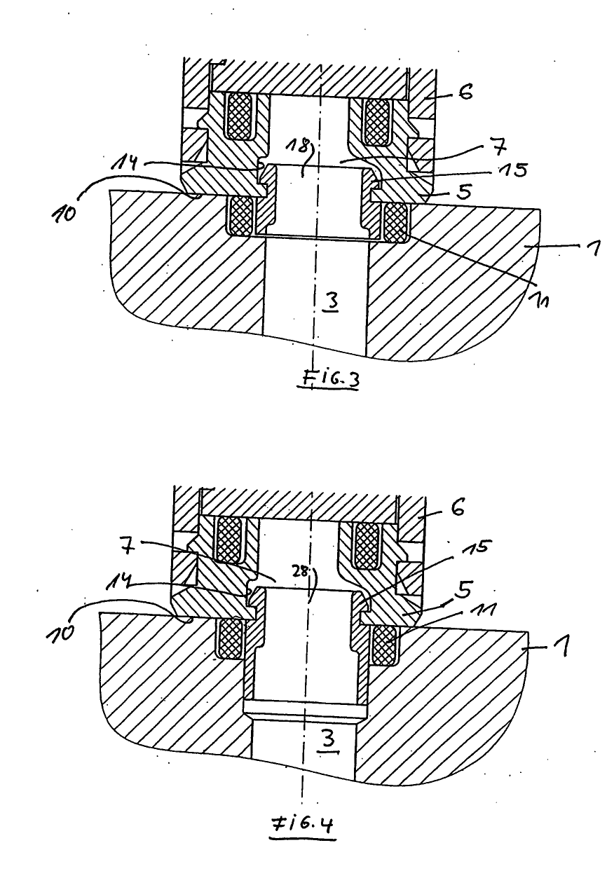

FIG. 3 shows an embodiment which is modified relative to FIG. 1;

FIG. 4 shows a remodified embodiment.

FIG. 1 shows in heavily simplified representation a part of a fitting housing 1 having a flat face 2. Opening out into this flat face is a water conduit 3, which is intended to be connected to a valve cartridge 4. The valve cartridge 4 contains at the end facing the fitting 1 a cartridge base 5, which is snap-locked into the housing 6 of the valve cartridge. This cartridge base 5 likewise contains an opening 7, into which the water leaving the water discharge opening of the water conduit 3 is intended to make its way.

The opening 7 is widened in its end region on one side. Into the opening 7 a sleeve 8 is inserted, which is detained in the cartridge base 5 by tension. The depth of the insertion is limited by an outer shoulder 9. The sleeve 8 has a part which juts out over the outer side 10 of the cartridge base 5. This part engages in the widening of the end region of the water conduit 3. In the radial direction, it has a distance from the rim of this widening. A type of groove is thereby virtually formed, which surrounds the water conduit 3 in its end region. Inserted in this groove is a sealing ring 11, which takes care of the sealing between the cartridge base 5 and the fitting housing 1.

Whereas, in the known previous cartridge bases, such a groove is disposed in the end face of the cartridge base, i.e. the outer side of the cartridge base, such a groove for a seal is now simulated by the sleeve 8 and the fitting housing 1. It is not necessary for an actual groove to be made in the fitting housing, which would entail a complex manufacturing process.

Now to FIG. 2. In FIG. 2, in the end region of the water conduit 3 of the fitting housing 1, a seal 12 is inserted, which is pressed against the cartridge base 5 by a spring 13. For such a sealing system, a flat, smooth-surfaced cartridge base 5 is necessary. This too can be achieved with the cartridge base proposed by the invention, by simple removal of the sleeve 8.

In the embodiment according to FIG. 3, the opening 7 in the cartridge base has in the widened end region an undercut 14, in which latching projections 15 of the sleeve 18 engage. This allows the sleeve 18 to be snap-locked into the cartridge base 5, which is made thoroughly possible by the use of elastic material.

The interaction between that part of the sleeve 18 which juts out of the cartridge base 5 and the fitting 1 is here exactly the same as in the embodiment according to FIG. 1.

FIG. 4 shows an option similar to FIG. 3, in which the sleeve 28 is this time configured somewhat longer, with the result that it reaches farther into the fitting housing 1. It extends, in particular, farther into the fitting housing 1 than corresponds to the depth of the groove formed between its radial outer side and the widening.

1. A cartridge base for a valve cartridge of a sanitary fitting, comprising:
a securing device for securing the cartridge base to a cartridge housing,
at least one opening leading inside the cartridge housing, and further comprising
a receiving fixture for a sleeve, which is insertable into the opening in the cartridge base from an outer side thereof, juts out over an outer face of the cartridge base and can be secured, at least temporarily, in the cartridge base.

2. The cartridge base as claimed in claim 1, wherein an outer end region at the opening is configured as a receiving fixture.

3. The cartridge base as claimed in claim 1, wherein the sleeve is secured in the cartridge base by a force closure.

4. The cartridge base as claimed in claim 1 wherein the opening is widened at the outer face of the cartridge base.

5. The cartridge base as claimed in claim 1 wherein the outer face of the cartridge base outside at least one said opening is smooth-surfaced.

6. The cartridge base as claimed in claim 1 wherein the opening in the cartridge base has, in side walls at the opening, an undercut for engagement of latching elements of the sleeve.

7. The cartridge base as claimed in claim 1 wherein the opening in the cartridge base has, in side walls at the opening, latching elements for engagement in undercuts in the sleeve.

8. The cartridge base as claimed in claim 1 wherein an outer side of a part of the sleeve which juts out of the cartridge base is smooth-surfaced.

9. In combination, a cartridge base and a fitting housing, wherein the cartridge base comprises a securing device for securing the cartridge base to a cartridge housing, at least one opening leading inside the cartridge housing, and a receiving fixture for a sleeve, which is insertable into the opening in the cartridge base from an outer side thereof, juts out over an outer face of the cartridge base, and can be secured, at least temporarily, in the cartridge base, and the fitting housing comprises a widening which surrounds a water discharge opening and has a shoulder.
